(19) United States
(12) Patent Application Publication
(10) Pub. No.: US 2008/0141524 A1
(43) Pub. Date: Jun. 19, 2008

(54) Refrigerating Apparatus Assembling Method

(76) Inventor: Atsushi Yoshimi, Osaka (JP)

Correspondence Address: BIRCH STEWART KOLASCH & BIRCH, PO BOX 747, FALLS CHURCH, VA, 22040-0747, US

(21) Appl. No.: 11/883,239

(22) PCT Filed: Jan. 31, 2006
(86) PCT No.: PCT/JP2006/001531

§ 371 Date: Jul. 26, 2007

(30) Foreign Application Priority Data
Feb. 16, 2005 (JP) 2005-039390

(51) Int. Cl. B23P 15/26

(52) U.S. Cl. 29/726

(57) ABSTRACT

After a refrigerant circuit (10) is formed by connecting a user side circuit (12) and a heat source side circuit (11) by means of a communication pipe (45), a compressor (21) is driven to circulate refrigerant in the refrigerant circuit (10) in a communication pipe cleaning step. Circulation of the refrigerant in the refrigerant circuit (10) peels off oxide which has been deposited on the inner face of the communication pipe (45) by brazing in the communication pipe forming step. The peeled oxide is forced to flow by the refrigerant to be collected on the upstream side of the compressor (21) in the heat source side circuit (11).

### TECHNICAL FIELD

The present invention relates to a method for assembling a refrigerating apparatus including a communication pipe of a plurality of pipes joined to each other by brazing.

### BACKGROUND ART

Conventionally, refrigerating apparatuses have been known which include a refrigerant circuit performing a vapor compression refrigeration cycle by circulating refrigerant. The refrigerant circuit of a refrigerating apparatus of this kind is formed by connecting an indoor unit including a user side circuit and an outdoor unit including a heat source side circuit to each other by means of a communication pipe (for example, Patent Document 1).

For a refrigerating apparatus of this kind, the indoor unit and the outdoor unit manufactured in a factory are conveyed to an installation site and assembled therein. In assembling the refrigerating apparatus, the indoor unit and the outdoor unit are set at the respective set positions, and then, the units are connected by means of a communication pipe to form the refrigerant circuit.

For a refrigerating apparatus of this kind, if the communication pipe is long, a step of forming the communication pipe by joining a plurality of pipes to each other is carried out on the installation site. For joining the pipes to each other on the installation site, brazing in which a solder is melted in a gap at a joint part between the pipes to join the pipes is employed in many cases. Brazing is employed especially in the case where the communication pipe is made of copper.

### Patent Document 1: Japanese Patent Application Laid Open Publication No. 2003-314909

### SUMMARY OF THE INVENTION

### Problems that the Invention is to Solve

For brazing, the joint part of the pipes is heated by a gas burner or the like to melt the solder. When the joint part of the pipes is heated, the heated part and the peripheral part therearound have high temperature to oxidize the surface of the high-temperature part in the presence of oxygen therearound, thereby generating oxide. If such oxide is deposited on the inner surface of the communication pipe of the assembled refrigerating apparatus, flowing refrigerant will peel off the oxide to cause troubles, such as disorder of the compressor, leakage of refrigerant from the expansion valve, and the like.

For this reason, an operation called nitrogen substitution in which nitrogen is sent into the pipes is carried out so as not to cause oxidation of the inner face of the pipes. Nitrogen substitution is required every time one joint part is brazed and involves conveyance of equipment, such as a nitrogen gas cylinder and the like, which means that nitrogen substitution is much complicated operation. As a result, in assembling a refrigerating apparatus including a communication pipe of a plurality of joined pipes, the step of forming the communication pipe involves much labor and effort. Particularly, the case where the refrigerating apparatus includes multiple indoor units and/or where the communication pipe is long requires repetitive brazing and nitrogen substitution to thus require considerable amounts of labor and effort.

The present invention has been made in view of the foregoing and has its object of providing a simple method for assembling a refrigerating apparatus including a communication pipe of a plurality of pipes joined to each other by brazing.

### Means for Solving the Problems

A first aspect of the present invention is directed to a method for assembling a refrigerating apparatus including a heat source side circuit (11), which includes a compressor (21) and a heat source side heat exchanger (24), and a user side circuit (12), which includes a user side heat exchanger (33). Wherein, the method includes the steps of: a communication pipe forming step of forming a communication pipe (45) by joining a plurality of pipes (46, 46, . . . ) to each other by brazing; a refrigerant circuit forming step of forming a refrigerant circuit (10) by connecting the heat source side circuit (11) and the user side circuit (12) by means of the communication pipe (45); and a communication pipe cleaning step of circulating refrigerant in the refrigerant circuit (10) by driving the compressor (21) after the refrigerant circuit forming step is completed for peeling off oxide generated and deposited in the communication pipe (45) in the communication pipe forming step to collect the peeled oxide on an upstream side of the compressor (21) in the heat source side circuit (11).

Referring to a second aspect of the present invention, in the communication pipe cleaning step in the first aspect, the oxide is collected by using a collecting member (40) through which the refrigerant passes only in the communication pipe cleaning step.

Referring to a third aspect of the present invention, in the communication pipe cleaning step in the first or second aspect, the refrigerant is circulated in a turbulent state in the refrigerant circuit (10).

Referring to a fourth aspect of the present invention, in the communication pipe cleaning step in any one of the first to third aspects, the refrigerant is circulated in such a way that the refrigerant discharged from the compressor (21) flows into the heat source side heat exchanger (24) and the user side heat exchanger (33) in this order in the refrigerant circuit (10) and is then returned to the compressor (21).

—Operation—

In the first aspect, the communication pipe (45) is formed by joining a plurality of pipes (46, 46, . . . ) to each other by brazing in the communication pipe forming step. Unlike the conventional case, this aspect performs no nitrogen substitution in which nitrogen is sent in joining the pipes (46, 46, . . . ) to each other by brazing. Accordingly, heating of the pipe (46) for brazing leads to oxidation of the inner face of the pipes (46), with a result that oxide is deposited on the inner face of the thus formed communication pipe (45). In this aspect, the communication pipe cleaning step is performed after the refrigerant circuit forming step is completed. In the communication pipe cleaning step, the compressor (21) is driven to circulate the refrigerant in the refrigerant circuit (10). When the refrigerant flows in the communication pipe (45), the shearing force works on the oxide deposited on the inner face of the communication pipe (45) to peel off the oxide. The peeled oxide is forced to flow by the refrigerant to be collected on the upstream side of the compressor (21) in the heat source side circuit (11).

In the second aspect, the collecting member (40) is used for collecting the oxide. The refrigerant is allowed to pass through the collecting member (40) only in the communication pipe cleaning step. In other words, no refrigerant flows through the collecting member (40) after assembling of the refrigerating apparatus (5) is completed.

In the third aspect, the refrigerant is circulated in a turbulent state in the refrigerant circuit (10) in the communication pipe cleaning step. For causing the turbulent flow of the refrigerant, the refrigerant must have a large flow rate to some extent. Therefore, in this aspect, the refrigerant is circulated at a comparatively large flow rate at which the refrigerant becomes in a turbulent state.

In the fourth aspect, the gas refrigerant discharged from the compressor (21) is condensed into liquid refrigerant in the heat source side heat exchanger (24), flows into the user side heat exchanger (33), is evaporated into gas refrigerant in the user side heat exchanger (33), and is then returned to the heat source side circuit (11). In other words, the refrigerant flows from the heat source side circuit (11) to the user side circuit (12) through the liquid side communication pipe (45a) and flows from the user side circuit (12) to the heat source side circuit (11) through the gas side communication pipe (45b). In general, the gas side communication pipe (45b) is larger in diameter than the liquid side communication pipe (45a), and accordingly, much oxide is deposited in the gas side communication pipe (45b) when compared with that in the liquid side communication pipe (45a). In this aspect, the gas side communication pipe (45b), in which much oxide is deposited by brazing, is located on the return side of the communication pipe (45) in which the refrigerant flows from the user side circuit (12) to the heat source side circuit (11).

### EFFECTS OF THE INVENTION

In the present invention, though oxide is deposited on the inner face of the communication pipe (45) in the communication pipe forming step, the oxide is peeled off from the communication pipe (45) and collected in the communication pipe cleaning step. Accordingly, with less or no oxide remaining in the communication pipe (45), driving of the refrigerating apparatus (5) after assembled causes no trouble in the compressor (21), the expansion valve (32), and the like, which has been caused due to the presence of oxide generated in assembling. Further, even if the number of joint parts to be brazed is increased, only one-time performance of the communication pipe cleaning step results in less or no oxide remaining deposited in the communication pipe (45). Accordingly, unlike the conventional method in which nitrogen substitution is performed, effort for preventing trouble caused due to the presence of oxide does not increase in proportion to an increase in to-be-brazed joint parts. This eliminates the need of nitrogen substation in which nitrogen is sent into the pipes (46, 46) in brazing with trouble of the refrigerating apparatus (5) caused due to the presence of oxide generated in assembling obviated to thus reduce the man-hour for assembling the refrigerating apparatus (5).

Referring to the second aspect, the refrigerant is not allowed to flow into the collecting member (40) after assembling of the refrigerating apparatus (5) is completed. The oxide collected at the collecting member (40) in the communication pipe cleaning step is retained in the collecting member (40) definitely even after assembling of the refrigerating apparatus (5) is completed. This definitely prevents trouble in the compressor (21), the expansion valve (32), and the like of the assembled refrigerating apparatus (5), which has been caused due to the presence of oxide generated in assembling.

In the third aspect, the refrigerant is circulated in the refrigerant circuit (10) at a comparatively large flow rate at which the refrigerant becomes in a turbulent state. When the refrigerant is circulated in a turbulent state in the refrigerant circuit (10), irregular flow is accompanied by the refrigerant to increase, in combination with the refrigerant at a large flow rate, the shearing force working on the oxide deposited in the communication pipe (45), thereby peeling off much more oxide. In addition, the force for causing the peeled oxide to flow increases, thereby reducing the amount of oxide remaining in the refrigerant circuit (10) as far as possible. Hence, the communication pipe (45) can be cleaned further reliably.

In the fourth aspect, the refrigerant is allowed to flow in the gas side communication pipe (45b), in which much oxide will be deposited, when the refrigerant flows toward the heat source side circuit (11) in which the oxide is collected. Accordingly, almost all oxide to be peeled off from the communication pipe (45) is peeled off from the gas side communication pipe (45b) after the refrigerant passes through the user side circuit (12), and flows directly into the heat source side circuit (11) to be collected on the upstream side of the compressor (21). Thus, almost all the peeled oxide is collected immediately after a part where it is peeled off, achieving reduction in amount of oxide remaining in the refrigerant circuit (10) as far as possible.

### BRIEF DESCRIPTION OF THE DRAWINGS

FIG. 1 is a schematic diagram showing a construction of a refrigerating apparatus assembled by a refrigerating apparatus assembling method in accordance with one embodiment.

FIG. 2 is a sectional view of joint parts of a communication pipe.

FIG. 3 is a sectional view of a recovery container in accordance with the embodiment.

FIG. 4 is a sectional view of a recovery container in accordance with Modified Example 3.

FIG. 5 is a sectional view of a recovery container in accordance with Modified Example 4.

FIG. 6 is a sectional view of a recovery container in accordance with Modified Example 5.

FIG. 7 is a sectional view of a recovery container in accordance with Modified Example 6.

FIG. 8 is a sectional view of a recovery container in accordance with Modified Example 7.

### EXPLANATION OF REFERENCE NUMERALS

10 refrigerant circuit
11 outdoor circuit (heat source side circuit)
12 indoor circuit (user side circuit)
21 compressor
24 outdoor heat exchanger (heat source side heat exchanger)
33 indoor heat exchanger (user side heat exchanger)
40 recovery container (collecting member)
45 communication pipe
46 pipe

### BEST MODE FOR CARRYING OUT THE INVENTION

One embodiment of the present invention will be described below in detail with reference to the accompanying drawings.

### Embodiment of the Invention

One embodiment of the present invention will be described, wherein description will be given first to a refrigerating apparatus assembled by the refrigerating apparatus assembling method in accordance with the present embodiment and then to the refrigerating apparatus assembling method in accordance with the present embodiment.

—Construction of Refrigerating Apparatus—

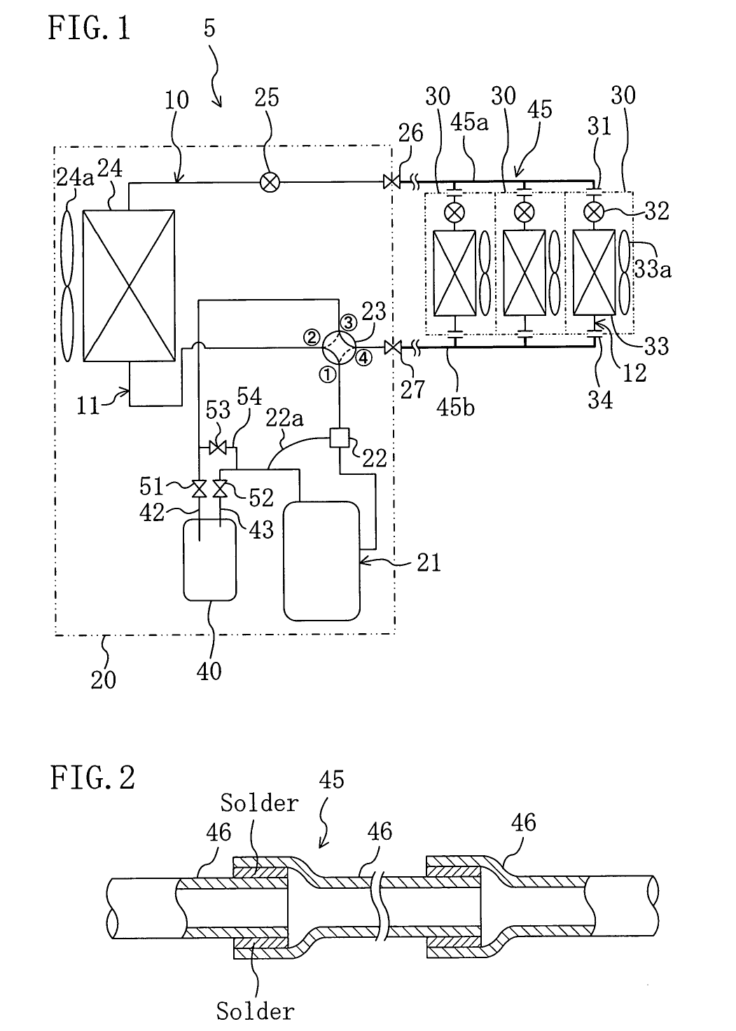

FIG. 1 is a schematic diagram showing a construction of a refrigerating apparatus (5) assembled by the refrigerating apparatus assembling method in accordance with the present embodiment. The refrigerating apparatus (5) is constructed as an air conditioner for performing temperature adjustment of indoor air.

The refrigerating apparatus (5) includes one outdoor unit (20) and three indoor units (30, 30, 30). The number of the indoor units (30) is a mere example and may be one, two, four, or more. An outdoor circuit (11) is provided in the outdoor unit (20) while an indoor circuit (12) is provided in each indoor unit (30). In the refrigerating apparatus (5), the outdoor circuit (11) is connected to the three indoor circuits (12, 12, 12) by means of a communication pipe (45), thereby forming a refrigerant circuit (10).

The communication pipe (45) is composed of a liquid side communication pipe (45a) and a gas side communication pipe (45b). The gas side communication pipe (45b) has a diameter larger than the liquid side communication pipe (45a). Each communication pipes (45a, 45b) is composed of a plurality of pipes (46, 46, . . . ) joined to each other. The pipes (46, 46, . . . ) are joined by brazing, as shown in FIG. 2. Brazing is a method for joining the pipes (46, 46, . . . ) to each other by melting a solder in a gap at a joint part between the pipes (46, 46, . . . ).

The three indoor circuits (12, 12, 12) are connected to the outdoor circuit (11) in parallel with each other. Specifically, the communication pipe (45) connected to the outdoor circuit (11) branches into three to be connected to the respective indoor circuits (12). A liquid side closing valve (26) and a gas side closing valve (27) are provided at the respective ends of the outdoor circuit (11). The liquid side closing valve (26) is connected to the liquid side communication pipe (45a) while the gas side closing valve (27) is connected to the gas side communication pipe (45b). A liquid side connector (31) and a gas side connector (34) are provided at the respective ends of each indoor circuit (12). The liquid side communication pipe (45a) is connected to each liquid side connector (31) while the gas side communication pipe (45b) is connected to each gas side connector (34).

The outdoor circuit (11) of the outdoor unit (20) serves as a heat source side circuit. In the outdoor circuit (11), a compressor (21), an oil separator (22), a four-way switching valve (23), and an outdoor heat exchanger (24) are connected to one another by means of a refrigerant pipe. The compressor (21) is a hermetic scroll compressor of generally-called high-pressure dome type. Electric power is supplied to the compressor (21) through an inverter. The compressor (21) is variable in its capacity in such a manner that the number of rotation of a compressor motor is changed by changing the output frequency of the inverter. The outdoor heat exchanger (24) is a cross-fin type fin-and-tube heat exchanger and serves as a heat source side heat exchanger. The outdoor unit (20) is provided with an outdoor fan (24a).

In the above outdoor circuit (11), the compressor (21) is connected at the discharge side thereof to the first port of the four-way switching valve (23) via the oil separator (22). The second port of the four-way switching valve (23) is connected to one end of the outdoor heat exchanger (24). The third port of the four-way switching valve (23) is connected to the suction side of the compressor (21) via a recovery container (40) that will be described later. The fourth port of the four-way switching valve (23) is connected to the gas side closing valve (27). The other end of the outdoor heat exchanger (24) is connected to the liquid side closing valve (26) via an outdoor expansion valve (25).

The outdoor circuit (11) is provided with the recovery container (40) used for collecting oxide in a communication pipe cleaning step that will be described later. The recovery container (40) is formed air-tightly and serves as a collecting member in accordance with the present invention. To the recovery container (40), an inflow pipe (42) and an outflow pipe (43) are connected. The inflow pipe (42) is connected to the third port of the four-way switching valve (23). An inflow valve (51) is provided at the inflow pipe (42). On the other hand, the outflow pipe (43) is connected to the suction side of the compressor (21). An outflow valve (52) is provided at the outflow pipe (43). The inflow valve (51) and the outflow valve (52) are on-off valves.

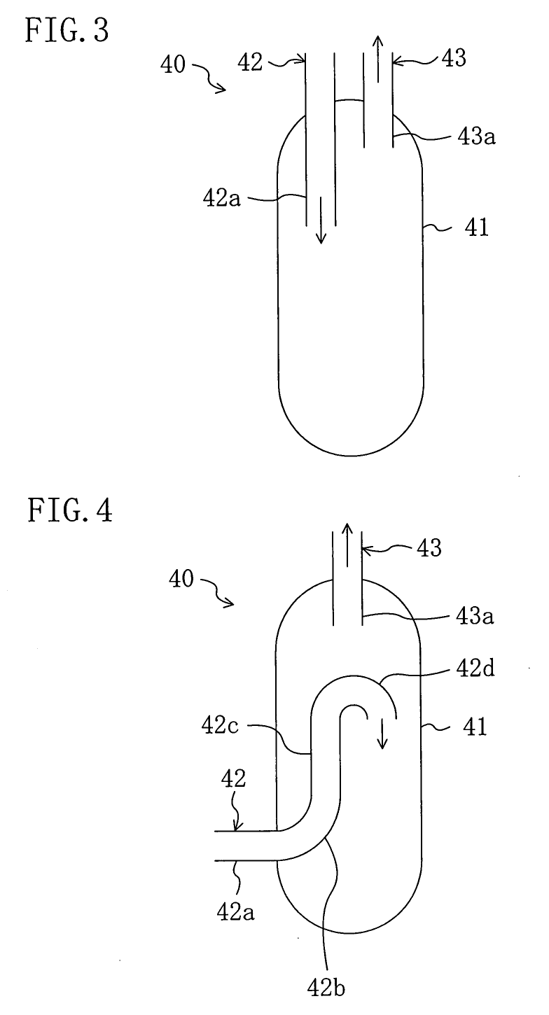

The inflow pipe (42) and the outflow pipe (43) are connected to the upper part of a casing (41) so as to pass through the upper wall of the casing (41), as shown in FIG. 3. The inflow pipe (42) includes a vertically extending straight pipe portion (42a) of which lower end serves as an outlet end, which is located at the central part in the casing (41). The outflow pipe (43) includes a vertically extending straight pipe portion (43a) of which lower end serves as an inlet end, which is located at the upper part in the casing (41). Namely, the outlet end of the inflow pipe (42) and the inlet end of the outflow pipe (43) are not opposed to each other but are opened in the same direction toward the bottom of the recovery container (40). The outlet end of the inflow pipe (42) is located lower than the inlet end of the outflow pipe (43). Accordingly, refrigerant flowing in the recovery container (40) through the inflow pipe (42) is prevented definitely from flowing directly into the outflow pipe (43).

Further, the outdoor circuit (11) is provided with a bypass pipe (54) allowing the refrigerant to bypass the recovery container (40). The bypass pipe (54) is connected at one end thereof between the inflow valve (51) and the third port of the four-way switching valve (23) while being connected at the other end thereof between the outflow valve (52) and the suction side of the compressor (21). The bypass pipe (54) is provided with a bypass valve (53) of an on-off valve.

To the oil separator (22), one end of an oil return pipe (22a) is connected. The other end of the oil return pipe (22a) is connected to a part between the outflow valve (52) and the suction side of the compressor (21) which is located downstream of the part connected to the bypass pipe (54). Composite oil mixed with gas refrigerant is discharged from the compressor (21), is separated from the gas refrigerant in the oil separator (22), passes through the oil return pipe (22a), and is then returned to the suction side of the compressor (21).

The indoor circuit (12) of each indoor unit (30) serves as a user side circuit. In each indoor circuit (12), an indoor expansion valve (32) and an indoor heat exchanger (33) are connected in series to each other by means of a refrigerant pipe. Each indoor heat exchanger (33) is a cross fin type fin-and-tube heat exchanger and serves as a user side heat exchanger. The indoor expansion valve (32) is an electronic expansion valve. Each indoor unit (30) is provided with an indoor fan (33a).

The refrigerant circuit (10) is exchanged between a cooling mode operation and a heating mode operation by switching the four-way switching valve (23). Specifically, when the four-way switching valve (26) is switched to a state in which the first port communicates with the second port while the third port communicates with the fourth port (a state shown by the solid lines in FIG. 1), the refrigerant is circulated in the refrigerant circuit (10) in the cooling mode operation in which the outdoor heat exchanger (24) operates as a condenser while each indoor heat exchanger (33) operates as an evaporator. In contrast, when the four-way switching valve (26) is switched to a state in which the first port communicates with the fourth port while the second port communicates with the third port (a state shown by the broken lines in FIG. 1), the refrigerant is circulated in the refrigerant circuit (10) in the heating mode operation in which the outdoor heat exchanger (24) operates as an evaporator while each indoor heat exchanger (33) operates as a condenser.

—Refrigerating Apparatus Assembling Method—

Description will be given to the method for assembling the above described refrigerating apparatus (5). Wherein, the below described method for assembling the refrigerating apparatus (5) is an assembling method for assembling refrigerating apparatus (5) in an installation site. The one outdoor unit (20) and the three indoor units (30, 30, 30) are manufactured in a factory and are conveyed to the installation site.

First, a step of setting the units (20, 30) is performed. In the setting step, the conveyed one outdoor unit (20) and the conveyed three indoor units (30) are set at predetermined set positions.

After the step of setting the units (20, 30) is completed, a communication pipe forming step is performed. In the case where a communication pipe (45) has a comparatively large diameter, pipes (46, 46) of, for example, approximately four meters are conveyed to the installation site and connected to each other therein. In the refrigerating apparatus (5), as well, adjacent pipes (46, 46) are joined to each other in the installation site to form the communication pipe (45). The pipes (46, 46) are joined to each other by brazing. When all the pipes (46, 46, . . . ) are joined to each other, the communication pipe forming step is completed. Brazing is performed in the air, so that oxide is deposited on the inner face of the communication pipe (45) after completion of the communication pipe forming step. Since the gas side communication pipe (45b) has a diameter larger than the liquid side communication pipe (45a), oxide will be deposited in the gas side communication pipe (45b) more than in the liquid side communication pipe (45a).

After the communication pipe forming step is completed, there are performed a step of mounting a drain pipe to each indoor unit (30), a step of covering the communication pipe (45) with a thermal insulator, a step of routing electric wirings in the units (20, 30), and the like. After these steps are completed, a refrigerant circuit forming step is performed. In the refrigerant circuit forming step, one end of the liquid side communication pipe (45a) is connected to the liquid side closing valve (26) of the outdoor unit (20), and the other end of the liquid side communication pipe (45a), which branches into three, is connected to the liquid side connectors (31) of the respective indoor units (30). As well, one end of the gas side communication pipe (45b) is connected to the gas side closing valve (27) of the outdoor unit (20), and the other end of the gas side communication pipe (45b), which branches into three, is connected to the gas side connectors (34) of the respective indoor units (30). Thus, the refrigerant circuit (10) of a closed circuit is formed in which the outdoor circuit (11), and the three indoor circuits (12) are connected to each other by means of the communication pipe (45).

After the refrigerant circuit forming step is completed, the refrigerant is filled in the refrigerant circuit (10). Thereafter, a leak test and vacuuming are performed. The leak test is performed for checking the presence or absence of leakage of the refrigerant. Vacuuming is performed for removing moisture and air in the refrigerant circuit (10) in a state in which the liquid side closing valve (26) and the gas side closing valve (27) are closed. After vacuuming is completed, the liquid side closing valve (26) and the gas side closing valve (27) are opened, and additional refrigerant filling is performed.

After additional refrigerant filling is completed, a communication pipe cleaning step is performed. In the communication pipe cleaning step, the inflow valve (51) and the outflow valve (52) are opened, and the bypass valve (53) is closed first. Then, the four-way switching valve (23) is switched to the state indicated by the solid lines in FIG. 1. In the communication pipe cleaning step, the compressor (21) is driven in this state. The capacity of the compressor (21) is set so that the refrigerant flows in a turbulent state in the refrigerant circuit (10). Further, in the communication pipe cleaning step, each opening of the outdoor expansion valve (25) and the indoor expansion valves (32) is adjusted appropriately. Since the four-way switching valve (23) is set in the state indicated by the solid lines in FIG. 1, the refrigerant discharged from the compressor (21) flows through the outdoor heat exchanger (24) and the indoor heat exchangers (33) in this order in the refrigerant circuit (10) and is then returned to the compressor (21).

When the compressor (21) is driven, compressed gas refrigerant is discharged from the compressor (21). The discharged gas refrigerant flows to the four-way switching valve (23) via the oil separator (22). The gas refrigerant having passed through the four-way switching valve (23) flows into the outdoor heat exchanger (24) to be heat-exchanged with outdoor air, thereby being condensed. Then, the refrigerant condensed to liquid passes through the outdoor expansion valve (25) and flows into the liquid side communication pipe (45a) via the liquid side closing valve (26).

The oxide generated in the communication pipe forming step has been deposited on the inner face of the liquid side communication pipe (45a). The oxide is peeled off and forced to flow by the liquid refrigerant flowing in the liquid side communication pipe (45a). Then, the liquid refrigerant including the oxide flows into the indoor units (30). In the indoor units (30), the liquid refrigerant passes through the indoor expansion valves (32) and flows into the indoor heat exchangers (33). In the indoor heat exchangers (33), the liquid refrigerant is heat-exchanged with indoor air to be evaporated. The evaporated refrigerant flows into the gas side communication pipe (45b) together with the oxide.

In the gas side communication pipe (45b), the oxide generated in the communication pipe forming step has been deposited. The oxide is peeled off and forced to flow by the gas refrigerant flowing in the gas side communication pipe (45b). Then, the gas refrigerant including the oxide flows into the recovery container (40) from the inflow pipe (42) via the gas side closing valve (27) and the four-way switching valve (23).

The oxide-including gas refrigerant flowing in the recovery container (40) is discharged toward the bottom of the recovery container (40). The oxide included therein is retained at the bottom of the recovery container (40). The gas refrigerant flows out from the recovery container (40) through the outflow pipe (43) to the refrigerant circuit (10) to be sucked into the compressor (21).

The communication pipe cleaning step is performed for a predetermined time period. This allows the oxide deposited on the inner faces of the liquid side communication pipe (45a) and the gas side communication pipe (45b) to be peeled off successively and then to be recovered into the recovery container (40), thereby removing the oxide from the liquid side communication pipe (45a) and the gas side communication pipe (45b).

After the communication pipe cleaning step is completed, the inflow valve (51) and the outflow valve (52) are closed, and the bypass valve (53) is opened. Thereafter, the inflow valve (51) and the outflow valve (52) are closed all the time while the bypass valve (53) is opened all the time. In this state, the cooling mode operation or the heating mode operation, which are normal operations, is performed by exchange therebetween.

—Cooling Mode Operation and Heating Mode Operation—

In the cooling mode operation, the four-way switching valve is set in the state indicated by the solid lines in FIG. 1. The refrigerant discharged from the compressor (21) flows into the oil separator (22), passes through the four-way switching valve (23), and is heat-exchanged with outdoor air in the outdoor heat exchanger (24) to be condensed. The condensed refrigerant passes through the outdoor expansion valve (25), flows through the liquid side communication pipe (45a), and is heat-exchanged with indoor air in the indoor heat exchangers (33) to be evaporated. Air cooled by heat-exchange in the indoor heat exchangers (33) is supplied indoors. The evaporated refrigerant flows through the gas side communication pipe (45b), passes through the four-way switching valve (23) and the bypass pipe (54), and is then returned to the suction side of the compressor (21).

In contrast, in the heating mode operation, the four-way switching valve is set in the state indicated by the broken lines in FIG. 1. The refrigerant discharged form the compressor (21) flows into the oil separator (22), passes through the four-way switching valve (23) and the gas side communication pipe (45b), and is heat-exchanged with indoor air in the indoor heat exchangers (33) to be condensed. The air heated by heat exchange by the indoor heat exchangers (33) is supplied indoors. The condensed refrigerant flows into the liquid side communication pipe (45a), passes through the outdoor expansion valve (25), and is heat-exchanged with outdoor air in the outdoor heat exchanger (24) to be evaporated. The evaporated refrigerant passes through the four-way switching valve (23) and the bypass pipe (54) and is then returned to the suction side of the compressor (21).

### Effects of Embodiments

In the present embodiment, though the oxide is deposited on the inner face of the communication pipe (45) in the communication pipe forming step, the thus deposited oxide is peeled off from the communication pipe (45) and is collected in the communication pipe cleaning step. Accordingly, less or no oxide remains deposited in the communication pipe (45) when the refrigerating apparatus (5) is driven after assembled, causing no trouble in the compressor (21), the expansion valve (32), and the like, which has been caused due to the presence of oxide generated in assembling. Further, even if the number of parts to be brazed is increased, the oxide is removed from the communication pipe (45) by only one-time performance of communication pipe cleaning step. This invites no increase in amount of work for preventing trouble caused due to the presence of oxide in proportion to an increase in the number of parts to be brazed. Accordingly, trouble in the refrigerating apparatus (5) caused due to the presence of oxide generated in assembling is obviated, and the man-hour for assembling the refrigerating apparatus (5) can be reduced with the need of nitrogen substitution in which nitrogen is sent into the pipes (46, 46) in brazing eliminated.

Moreover, in the present embodiment, the refrigerant is inhibited from flowing into the recovery container (40) after assembling of the refrigerating apparatus (5) is completed. The oxide collected in the recovery container (40) in the communication pipe cleaning step is retained in the recovery container (40) even in the cooling mode operation and the heating mode operation after assembling of the refrigerating apparatus (5) is completed. Accordingly, trouble in the compressor (21), the expansion valve (32), and the like, which has been caused due to the presence of oxide generated in assembling, can be obviated definitely.

Furthermore, in the present embodiment, the refrigerant is circulated at a comparatively large flow rate at which the refrigerant circuit (10) becomes in a turbulent state. When the refrigerant is circulated in the turbulent state in the refrigerant circuit (10), irregular flow is accompanied by the refrigerant to increase, in combination with of the refrigerant at large flow rate, the shearing force working on the oxide deposited in the communication pipe (45), thereby peeling further more oxide. The force causing the peeled oxide to flow increases also to reduce the amount of oxide remaining in the refrigerant circuit (10) as far as possible. Thus, the communication pipe (45) is cleaned reliably.

In addition, in the present embodiment, the refrigerant is allowed to flow through the gas side communication pipe (45b), in which much oxide will be generated, when the refrigerant flows toward the outdoor circuit (11) in which oxide is collected. Accordingly, almost all oxide to be peeled off from the communication pipe (45) is peeled off in the gas side communication pipe (45b) after the refrigerant passes through the indoor circuits (12), and flows directly into the outdoor circuit (11) to be collected on the upstream side of the compressor (21). Thus, almost all the peeled oxide is collected immediately after a part where it is peeled off, so that the amount of oxide remaining in the refrigerant circuit (10) can be reduced as far as possible.

### Modified Example 1 of Embodiment

In the above embodiment, the one compressor (21) is provided, of which capacity is set by adjusting the output frequency of the inverter. The present invention is not limited thereto, and a plurality of compressors (21) may be provided, of which capacity is set by changing the number of driven compressors (21).

### Modified Example 2 of Embodiment

In the above embodiment, the recovery container (40) is used as the collecting member but a filter (40) may be used. The filter (40) is provided in the refrigerant pipe between the inflow valve (51) and the outflow valve (52). The filter (40) passes the refrigerant only in the communication pipe cleaning step in assembling of the refrigerant apparatus (5). Preferably, the filter collects particles having a diameter of 100 μm or smaller.

### Modified Example 3 of Embodiment

Modified Example 3 of the embodiment will be described next. In Modified Example 3, the inlet pipe (42) of the recovery container (40) in the above embodiment is changed in position and shape. FIG. 4 is a sectional view of a recovery container (40) in Modified Example 3.

Specifically, the inlet pipe (42) is connected to the bottom of the side face of the casing (41). The inlet pipe (42) includes a straight pipe portion (42a) horizontally extending and passing through the side wall of the casing (41). The straight pipe portion (42a) continues to a curved portion (42b) upwardly curved in the casing (41). The curved portion (42b) has an upper end from which an upwardly extending straight pipe portion (42c) continues. Further, a downwardly-curved curved portion (42d) continues from the upper end of the straight pipe portion (42c). The lower end of the curved portion (42d) serves as the outlet end, which is located at the central part in the casing (41). Namely, the outlet end of the inflow pipe (42) is opened toward the bottom of the recovery container (40) so as not to be opposed to the inlet end of the outflow pipe (43) but so as to be directed in the same direction as the direction where the inlet end of the outflow pipe (43) is directed. The outlet end of the inflow pie (42) is located lower than the inlet end of the outflow pipe (43). Hence, the refrigerant flowing in the recovery container (40) through the inlet pipe (42) is prevented definitely from flowing directly into the outflow pipe (43).

### Modified Example 4 of Embodiment

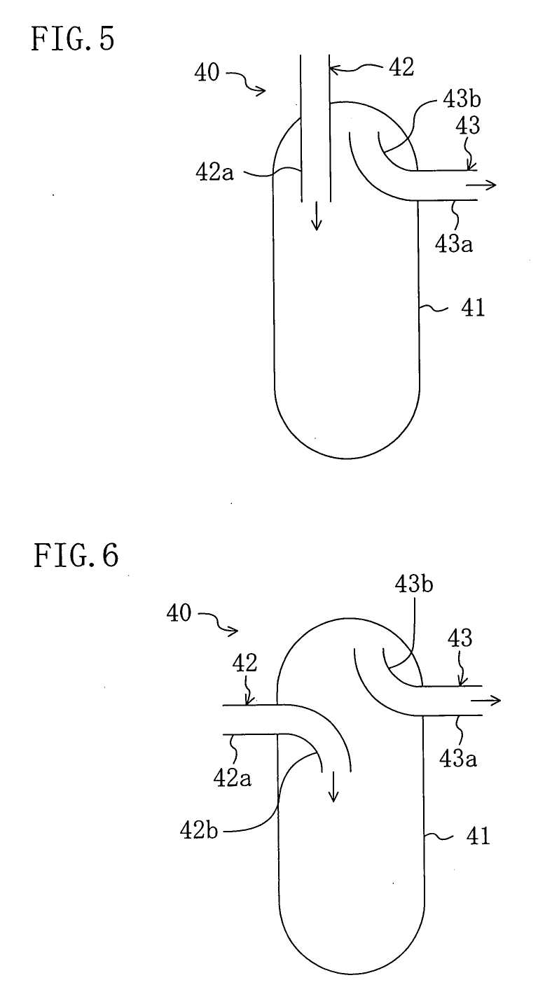

Modified Example 4 of the embodiment will be described next. In Modified Example 4, the outflow pipe (43) of the recovery container (40) in the above embodiment is changed in position and shape. FIG. 5 is a sectional view of a recovery container (40) in Modified Example 4.

Specifically, the outflow pipe (43) is connected to the upper part of the side face of the casing (41). The outflow pipe (43) includes a straight pipe portion (43a) horizontally extending and passing through the side wall of the casing (41). The straight pipe portion (43a) continues to a curved portion (43b) upwardly curved in the casing (41). The upper end of the curved portion (43b) serves as an inlet end, which is located at the upper part in the casing (41). Namely, the inlet end of the outflow pipe (43) is located upper than the outlet end of the inlet pipe (42) so that the inlet end and the outlet end are not opposed to each other but are directed in the opposite directions to each other. Hence, the refrigerant flowing in the recovery container (40) through the inflow pipe (42) is prevented definitely from flowing directly into the outflow pipe (43).

### Modified Example 5 of Embodiment

Modified Example 5 of the embodiment will be described next. In Modified Example 5, the inflow pipe (42) of the recovery container (40) in Modified Example 4 is changed in position and shape. FIG. 6 is a sectional view of a recovery container (40) in Modified Example 5.

Specifically, the inflow pipe (42) is connected to the upper part of the side face of the casing (41). The inflow pipe (42) includes a straight pipe portion (42a) horizontally extending and passing through the side wall of the casing (41). The straight pipe portion (42a) continues to a curved portion (42b) downwardly curved in the casing (41). The lower end of the curved portion (42b) serves as the outlet end, which is located at the central part in the casing (41). Namely, the outlet end of the inflow pipe (42) is located lower than the inlet end of the outflow pipe (43) so that the outlet end and the inlet end are not opposed to each other but are directed in the opposite directions to each other. Hence, the refrigerant flowing in the recovery container (40) through the inflow pipe (42) is prevented definitely from flowing directly into the outflow pipe (43).

### Modified Example 6 of Embodiment

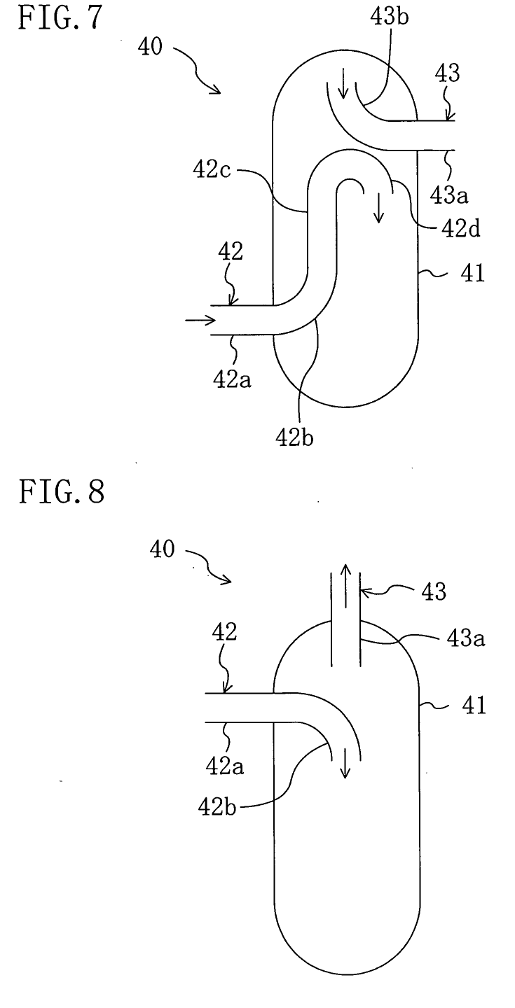

Modified Example 6 of the embodiment will be described next. In Modified Example 6, the position and the shape of the outflow pipe (43) of the recovery container (40) in Modified Example 3 are changed to those of the outflow pipe (43) of the recovery container (40) in Modified Example 4. FIG. 7 is a sectional view of a recovery container (40) in Modified Example 6.

Specifically, the inlet end of the outflow pipe (43) is located upper than the outlet end of the inflow pipe (42) so that the inlet end and the outlet end are not opposed to each other but are directed in the opposite directions to each other. Hence, the refrigerant flowing in the recovery container (40) through the inflow pipe (42) is prevented definitely from flowing directly into the outflow pipe (43).

### Modified Example 7 of Embodiment

Modified Example 7 of the embodiment will be described next. In Modified Example 7, the position and the shape of the inflow pipe (42) of the recovery container (40) in Modified Example 3 are changed to those of the inflow pipe (42) of the recovery container (40) in Modified Example 5. FIG. 8 is a sectional view of a recovery container (40) in Modified Example 7.

Specifically, the inlet end of the outflow pipe (43) is located upper than the outlet end of the inflow pipe (42) so that the inlet end and the outlet end are not opposed to each other but are directed in the opposite directions to each other. Hence, the refrigerant flowing in the recovery container (40) through the inflow pipe (42) is prevented definitely from flowing directly into the outflow pipe (43).

The above described embodiments are substantially preferable examples and are not intended to limit the present invention, applicable matters, uses, and the scope.

### INDUSTRIAL APPLICABILITY

As described above, the present invention is useful for methods for assembling a refrigerating apparatus including a communication pipe of a plurality of pipes joined to each other by brazing.

1. A method for assembling a refrigerating apparatus including a heat source side circuit (11), which includes a compressor (21) and a heat source side heat exchanger (24), and a user side circuit (12), which includes a user side heat exchanger (33), comprising the steps of:
a communication pipe forming step of forming a communication pipe (45) by joining a plurality of pipes (46, 46, . . . ) to each other by brazing;
a refrigerant circuit forming step of forming a refrigerant circuit (10) by connecting the heat source side circuit (11) and the user side circuit (12) by means of the communication pipe (45); and
a communication pipe cleaning step of circulating refrigerant in the refrigerant circuit (10) by driving the compressor (21) after the refrigerant circuit forming step is completed for peeling off oxide generated and deposited in the communication pipe (45) in the communication pipe forming step to collect the peeled oxide on an upstream side of the compressor (21) in the heat source side circuit (11).

2. The method of claim 1,
wherein in the communication pipe cleaning step, the oxide is collected by using a collecting member (40) through which the refrigerant passes only in the communication pipe cleaning step.

3. The method of claim 1 or 2,
wherein in the communication pipe cleaning step, the refrigerant is circulated in a turbulent state in the refrigerant circuit (10).

4. The method of claim 1 or 2,
wherein in the communication pipe cleaning step, the refrigerant is circulated in such a way that the refrigerant discharged from the compressor (21) flows into the heat source side heat exchanger (24) and the user side heat exchanger (33) in this order in the refrigerant circuit (10) and is then returned to the compressor (21).
